(19) United States
(12) Patent Application Publication
(10) Pub. No.: US 2026/0349462 A1
(43) Pub. Date: Nov. 5, 2026

(54) LOCKOUT DEVICE FOR CRANE REMOTE CONTROLLER

(71) Applicant: Toyota Motor Engineering & Manufacturing North America, Inc., Plano, TX (US)

(72) Inventors: Alan M. Partington, Kitchener (CA); Shakti Taneja, Waterloo (CA)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/196,335

(22) Filed: May 1, 2025

(51) Int. Cl. G05G 5/00; B66C 13/40; G05G 1/04

(52) U.S. Cl. CPC G05G 5/005; B66C 13/40; G05G 1/04; G05G 2505/00

(57) ABSTRACT

A lockout device for a crane remote controller includes a first bearing portion defining a first bearing plane, and a second bearing portion defining a second bearing plane intersecting the first bearing plane. A base extends between and connects the first and second bearing portions. A static arm structure including an arm extends from the base. The lockout device is mountable on a remote controller configured to control operations of the crane. The controller incorporates therein one or more control modules with each module having a paddle configured to be rotatable to control an associated motion or activity of the crane. The lockout device is mounted on the controller so that the arm structure engages the paddle on an associated control module to prevent rotation of the paddle, thereby locking out the control function controlled by the control module.

### TECHNICAL FIELD

The present invention relates to controllers for controlling operation of a crane in a manufacturing environment and, more particularly, to a device for locking out a specified manual control of the controller to prevent operation of the control to affect the crane.

### BACKGROUND

An overhead crane operating in a manufacturing environment may be controlled by a wireless remote controller. The controller may have various toggles, buttons, paddles and/or other manually operable control interfaces configured to control parameters such as an associated motion of the crane along x, y, and z axes, speed of motion along each axis, etc. Currently, when a wireless controller as described herein is operatively connected to a crane to control crane operations, the entire crane must be fully locked down during crane maintenance activities to prevent undesired movement of any portion of the crane due to inadvertent operation of the controller paddles. Locking down of the entire crane is a laborious and time-consuming process. Thus, a need exists for a way to selectively “lock out” crane controls to prevent inadvertent or unauthorized operation of one or more crane remote controls without locking down the entire crane.

### SUMMARY

In one aspect of the embodiments described herein, a lockout device for a crane remote controller is provided. The lockout device includes a first bearing portion defining a first bearing plane, and a second bearing portion defining a second bearing plane intersecting the first bearing plane. A base extends between and connects the first and second bearing portions. A static arm structure including an arm extends from the base.

In another aspect of the embodiments described herein, a controller assembly for an overhead crane is provided. The assembly includes a controller having a control module including a paddle configured to be rotatable to control an operation of the crane, and a lockout device mounted to the controller and including a static arm structure structured to engage the paddle to prevent rotation of the paddle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale. Also, unless otherwise stated or shown, the same or similar elements shown in different views may be given the same or similar reference numerals or designations.

FIG. 1 is a schematic perspective view of a wireless remote controller for an overhead crane (not shown) in accordance with an embodiment described herein.

FIG. 2 is a schematic perspective view of a lockout device in accordance with an embodiment described herein.

FIG. 3 is a schematic front perspective view of the controller of FIG. 1 with the lockout device of FIG. 2 mounted in the controller exterior cavity so as to prevent operation of an associated control module.

FIG. 4 is a schematic perspective view of a lockout device in accordance with an alternative embodiment described herein.

FIG. 5 is a schematic perspective view of a lockout device in accordance with another alternative embodiment described herein.

### DETAILED DESCRIPTION

A lockout device for a crane remote controller includes a first bearing portion defining a first bearing plane, and a second bearing portion defining a second bearing plane intersecting the first bearing plane. A base extends between and connects the first and second bearing portions. A static arm structure including an arm extends from the base. The lockout device is mountable on a remote controller configured to control operations of the crane. The controller incorporates therein one or more control modules with each module having a paddle configured to be rotatable to control an associated motion or activity of the crane. The lockout device is mounted on the controller so that the arm structure engages the paddle on an associated control module to prevent rotation of the paddle, thereby locking out the control function controlled by the control module.

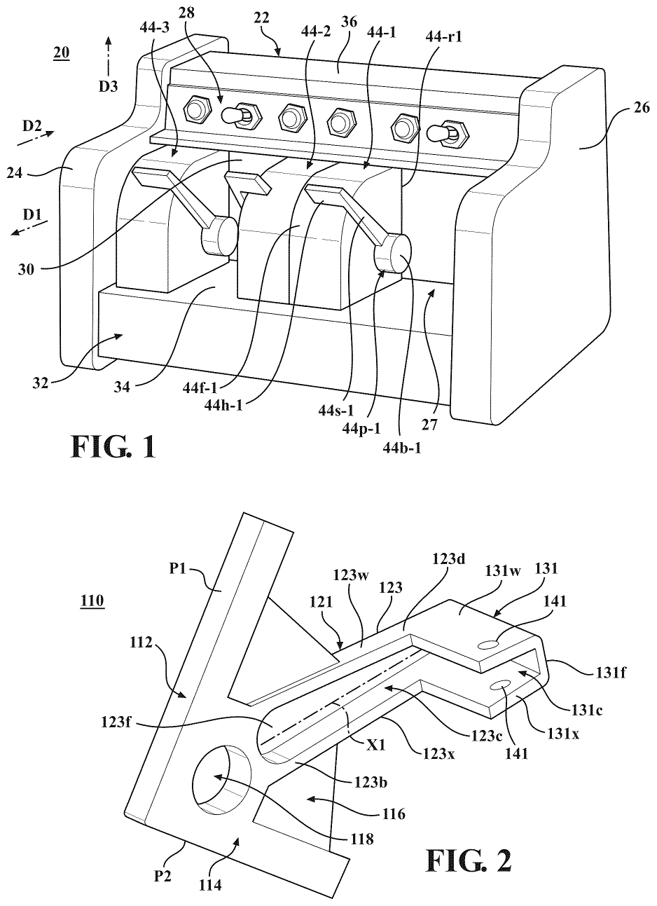

FIG. 1 is a schematic perspective view of a wireless remote controller 20 for an overhead crane (not shown) in accordance with an embodiment described herein. The crane remote controller 20 may include a housing 22. As used herein, the terms “front-facing” and “forward-facing” refer to surfaces or walls of the housing 22 structured to face in a direction toward a user when the user is operating the controller 20. In the arrangement shown in FIG. 1, the front-facing direction is indicated by arrow D1. As used herein, the term “upwardly-facing” refers to surfaces of the remote controller 20 structured to face in an upward direction D3 (i.e., in a direction generally perpendicular to direction D1) when the user is operating the controller 20.

For example, front-facing walls in the controller of FIG. 1 include control panel 28, first bearing wall 30 (described below) and lower face 32. the front-facing walls may be include printing, status indicators, operable controller controls and/or other features configured to be visible and manually accessible to a user facing in a general direction D2 opposite the direction D1. In the arrangement shown in FIG. 1, upwardly-facing surfaces include the second bearing wall 34 and housing top wall 36.

The housing 22 may include elements such as crane and controller status indicators and electrical and mechanical components configured for converting or translating crane control commands generated by a user into signals executable by actuators mounted on the crane and/or other elements. walls of the housing 22 (such as first bearing wall 30, second bearing wall 34, housing top wall 36, first and second side walls 24, 26 and the other walls), in combination, define an interior of the housing. A wireless control interface (not shown) may be mounted in the housing interior and may be configured for wireless communication with a complementary wireless interface, one or more controllers, actuators, and/or other elements mounted on the crane and configured to receive and implement crane control commands.

The controller 20 may include a first side wall 24 attached to a first side of the housing 22 and a second side wall 26 attached to a second side of the housing 22 opposite the first side. The housing 22 may include control panel 28 having an array of buttons, switches and/or other controls (e.g., an “on/off” switch) configured for controlling functions of the remote controller other than movement and other operations of the overhead crane.

The housing 22 may include a front-facing, generally vertically-extending first bearing wall 30, and an upwardly-facing second bearing wall 34 extending generally horizontally from the first bearing wall 30. In combination, first bearing wall 30, second bearing wall 34, first side wall 24 and second side wall 26 may define an exterior cavity 27 of the controller 20. As seen in FIG. 1, control panel 28 may extend between the first and second side walls 24, 26 and above the exterior cavity 27.

The exterior cavity 27 may be structured to receive one or more crane control modules 44 for mounting therein. The controller 20 shown in the drawings includes three crane control modules, 44-1, 44-2 and 44-3 having similar physical characteristics as described herein. Referring to module 44-1, for example, each crane control module 44 may have a rear face (such as rear face 44r-1) structured to abut the first bearing wall 30 when the control module is mounted in the exterior cavity 27 for performance of its control functions. Each control module 44 may have a semi-cylindrical front face (such as face 44f-1) including markings indicating a type of crane motion (e.g., along an x, y or z-axis) controlled by the module. Each module 44 may include a spring-loaded paddle or toggle (such as paddle 44p-1) operatively connected to associated electro-mechanical crane control elements (e.g., a potentiometer) contained inside module. Each paddle may have a base (such as base 44b-1) extending from an interior of the module to the module exterior along a side of the module. The base 44b-1 may be rotatably coupled to an element in an interior of the module 44-1 in order to implement the control function of the module. A stem (such as stem 44s-1) may extend from the base 44b-1 toward the module face 44f-1, and a handle (such as handle 44h-1) may extend from the stem 44s-1 to overlie the face 44f-1. In some arrangements, the stem 44s-1 may taper so as to gradually narrow in a direction proceeding from the base 44b-1 toward the handle 44h-1. To control the crane, a user manipulates the handle 44h-1 to rotate the paddle 44p-1 to produce a crane motion corresponding to one of the markings on the module face 44f-1.

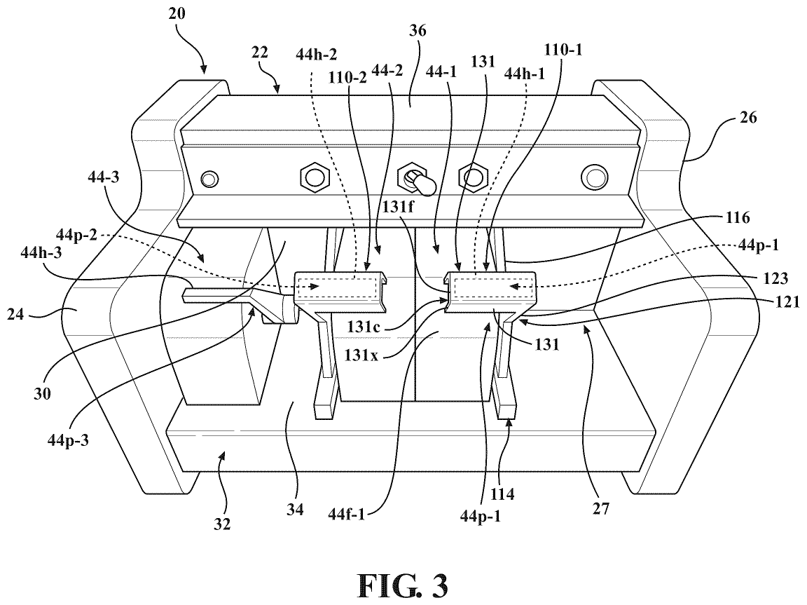

The paddle 44p-1 may be mechanically coupled to one or more elements (e.g., one or more spring elements) in an interior of the control module 44-1 structured to automatically rotate the paddle 44p-1 so as to locate the handle 44h-1 in a position overlying a predetermined portion 44p-1 of the face 44f-1 when the handle 44h-1 is not being manipulated by a user. The predetermined portion 44p-1 of the face 44f-1 may correspond to a default neutral angular position of the paddle 44p-1 in which no crane control functions are selected or activated. The control modules 44 of FIGS. 1 and 3 are shown with their respective paddles in respective default neutral angular positions. In particular arrangements, the paddle 44p-1 may be configured so that the stem 44s-1 extends at an angle of 45°±5° with respect to one of the first bearing wall 30 and the second bearing wall 34 when the paddle 44p-1 resides in the neutral angular position and the control module 44-1 is mounted in the exterior cavity 27 as shown in FIG. 1.

Control modules 44-2 and 44-3 may have characteristics similar to those just described for module 44-1.

FIG. 2 is a schematic perspective view of a lockout device 110 in accordance with an embodiment described herein. The lockout device 110 may include a first bearing portion 112 defining a first bearing plane P1 and a second bearing portion 114 defining a second bearing plane P2 intersecting the first bearing plane P1. In one or more arrangements, the second bearing plane P1 extends substantially orthogonally with respect to the first bearing plane P1. As used herein, “substantially orthogonally” means that the second bearing plane P2 forms an angle within a range of 90°±(tolerance value) with the first bearing plane P1. In particular arrangements, the tolerance value is 5°.

The lockout device 110 may include a base 116 extending between and connecting the first and second bearing portions 112, 114. In one or more arrangements, a hole 118 may be formed in the base 116. The hole 118 may be structured for receiving therein a portion of the base 44b of a paddle 44p of an associated control module 44 when the lockout device 110 is mounted in the controller exterior cavity 27 as described herein. In some arrangements, the hole 118 may be structured to contact the paddle base 44b in a slight interference fit to help retain the lockout device 110 in the exterior cavity 27.

The lockout device 110 may include an arm structure 121 including an arm 123 extending from the base 116. Then arm structure may be a static arm structure (i.e., the arm structure does not move with respect to the first and second bearing portions 112, 114 and the base 116). The arm 123 may have a base end 123b connected to the base 116 and a distal end 123d positioned opposite the base end 123b. The arm 123 may have a central longitudinal axis X1. The arm 123 may be structured so that the axis X1 extends parallel to a rotatable stem 44s of an associated control module 44 when the control module is mounted in the exterior cavity 27 and the lockout device 110 is mounted on the control module. In some arrangements, the arm may be structured so that the axis X1 extends at an angle of 45°±5° with respect to one of the first and second bearing planes when the control module is mounted in the exterior cavity 27.

In one or more arrangements, the arm 123 includes an arm cavity 123c extending therealong. The arm cavity 123c may be structured to receive therein at least a portion of a stem 44s of a rotatable paddle 44p of an associated control module 44 mounted in the controller exterior cavity 27 when the lockout device 110 is also mounted in the cavity 27 as previously described. In particular arrangements, the arm cavity 123c is tapered so as to narrow in a direction extending from the arm base end 123b toward the arm distal end 123d. the cavity 123c may be defined by a first arm wall 123w, a second arm wall 123x positioned opposite the first arm wall 123w, and an arm cavity floor 123f extending between the first and second arm walls 123w, 123x.

In one or more arrangements, the arm structure 121 also includes a projection 131 extending from the distal end 123d of the arm 123. The projection 131 may include a projection cavity 131c extending therealong. The projection cavity 131c may be structured to receive therein at least a portion of a handle 44h-1 of a paddle 44p-1 rotatably coupled to an element in an interior of an associated control module 44-1 mounted in the controller exterior cavity 27 when the lockout device 110 is also mounted in the cavity 27 as previously described. the projection cavity 131c may be defined by a first projection wall 131w, a second projection wall 131x positioned opposite the first arm wall 131w, and an projection cavity floor 131f extending between the first and second projection walls 131w, 131x.

Referring again to FIG. 2, in some arrangements, a lock hole 141 may be formed in each of the first projection wall 131w and the second projection wall 131x. The lock holes 141 may be structured to receive a portion of a lock (such as a cable of a cable lock, not shown) therethrough when a portion of the paddle handle 44h-1 is received in the projection cavity 131c. The lock may prevent unauthorized removal of the projection 131 from the control module handle 44h-1.

FIG. 3 is a schematic front perspective view of the controller 20 of FIG. 1 with the lockout device 110 of FIG. 2 mounted in the controller exterior cavity 27 so as to prevent operation of an associated control module 44-1. In the embodiment shown in FIGS. 1-3, the lockout device 110 may be positioned in the controller exterior cavity 27 so that each one of bearing planes P1 and P2 abuts an associated one of the first bearing wall 30 and the second bearing wall 34, so that the base 44b-1 of paddle 44p-1 of an associated control module 44-1 extends into the hole 118, and so that a portion of the paddle stem 44s-1 is received in the arm cavity 123c. Referring to FIGS. 1-3, when the lockout device 110 is mounted in the exterior cavity 27 and at least a portion of the stem 44s-1 is received in the arm cavity 123c, the arm structure 121 does not move relative to the controller 20. Also, the arm 123 engages the stem 44s-1 so as to prevent rotation of the paddle 44p-1. As used herein, “preventing rotation” of the paddle includes both preventing any rotation of the paddle and also preventing rotation of the paddle other than rotation allowed by any slight clearance between the arm cavity first and second walls 123w, 123x and the stem 44s-1 received in the arm cavity 123c). “Engagement” between a paddle and an arm structure means that a portion of the paddle is received in a cavity of the arm structure so that rotation of the paddle is prevented as described. This effectively prevents operation of the control module 44-1, thereby locking out the associated control functions performed by the control module 44-1. The tapered shape of the arm cavity 123c may be structured to closely conform to the shape of the stem 44s-1 provided in some embodiments of a control module paddle 44p-1 to be received in the cavity 123c when the lockout device 110 is mounted on the crane remote controller 20, so as to prevent operation of the control module 44-1 as described herein. This may aid in restricting rotational motion of the paddle 44p-1 when a portion of the paddle is received in the arm cavity 123c. Selective lockout out the control module(s) allows for greater flexibility during crane maintenance and prevents unauthorized use of the crane controls.

Also, when the lockout device 110 is mounted in the exterior cavity 27 and at least a portion of the paddle handle 44h-1 is received in the projection cavity 131c, the projection 131 engages the handle 44h-1 so as to prevent rotation of the arm structure 121 (other than rotation allowed by any slight clearance between the projection cavity first and second walls 131w, 131x and the handle 44h-1 received in the arm cavity). This effectively prevents operation of the control module 44-1, thereby locking out the associated control functions performed by the module.

A lockout device in accordance with any of the embodiments described herein may be positioned along either side of an associated control module 44-1 to prevent rotation of an associated paddle 44p-1, by simply moving the lockout device from a first side of the control module to a second, opposite side of the control module and rotating the lockout device to provide a “mirror-image” of the orientation the device has when the device is positioned on the first side of the control module. For example, FIG. 3 shows a first control module 44-1 mounted to the controller housing 22 and including a paddle 44p-1. a first lockout device 110-1 structured as shown in FIG. 2 is mounted in the housing as previously described adjacent the control module 44-1, with a stem 44s-1 (not shown) of paddle 44p-1 received in arm cavity 123c of the first lockout device 110-1 and handle 44h-1 of the paddle 44p-1 received in projection cavity 131c of the first lockout device 110-1, to prevent rotation of the paddle 44p-1. Similarly, a second control module 44-2 mounted to the controller housing 22 adjacent the first control module 44-1 includes an associated paddle 44p-2. a second lockout device 110-2 structured as shown in FIG. 2 is oriented 180° with respect to the first lockout device 110-1 and then mounted in the housing 22 as previously described adjacent control module 44-2. The paddle 44p-2 extends along a side of the control module 44-2 opposite the side of the module 44-1 along which paddle 44p-1 extends. stem 44s-2 (not shown) of associated paddle 44p-2 is received in arm cavity 123c of the second lockout device 110-2 and handle 44h-2 of the paddle 44p-2 is received in projection cavity 131c of the second lockout device 110-2, to prevent rotation of the paddle 44p-2.

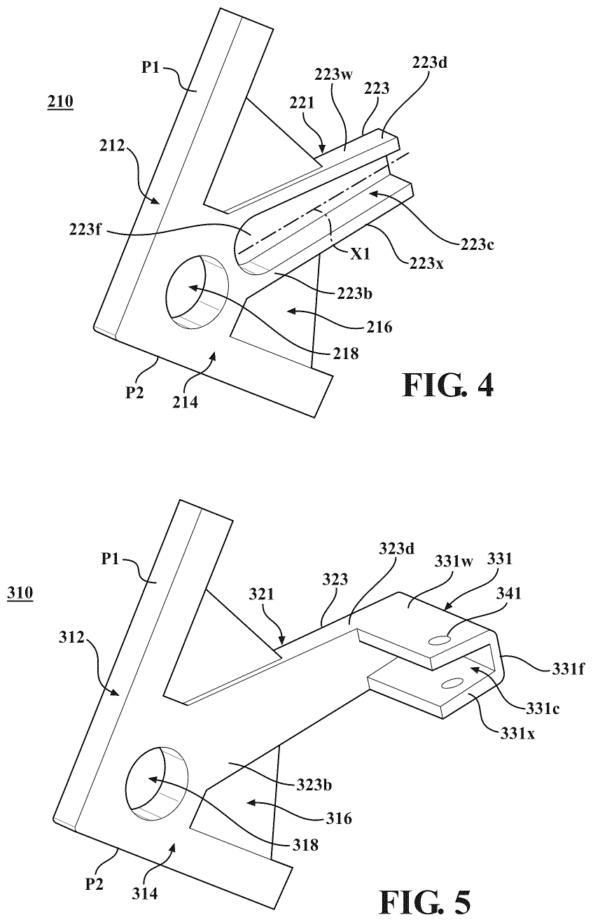

FIG. 4 is a schematic perspective view of a lockout device 210 in accordance with an alternative embodiment described herein. this embodiment includes a first bearing portion 212 defining a first bearing plane P1, a second bearing portion 214 defining a second bearing plane P2 intersecting the first bearing plane P1, and a base 216 structured similarly to the embodiment shown in FIG. 2. Lockout device 210 also includes an arm structure 221 having an arm 223 with a cavity 223c defined by walls 223w, 223x and floor 223f as in the previously-described embodiment (FIG. 2). However, lockout device 210 lacks a projection extending from a distal end 223d of the arm 223. A stem 44s-1 of a paddle 44p-1 is received in the arm cavity 223c as previously described to provide engagement between the arm 223 and the stem 44s-1 and prevent rotation of the paddle 44p-1.

FIG. 5 is a schematic perspective view of a lockout device 310 in accordance with another alternative embodiment described herein. this embodiment includes a first bearing portion 312 defining a first bearing plane P1, a second bearing portion 314 defining a second bearing plane P2 intersecting the first bearing plane P1, and a base 316 structured similarly to the embodiment shown in FIG. 2. Lockout device 310 also includes an arm structure 321 having an arm 323. This embodiment includes an arm structure 321 having an arm 323 and a projection 331 extending from a distal end 323d of the arm 323, as previously described. However, the arm 323 does not incorporate an arm cavity. Rather, engagement between the arm structure 321 and the paddle 44p-1 is provided by positioning the paddle handle 44h-1 in a projection cavity 331c defined by associated walls 331w, 331x and floor 331f as previously described, to prevent rotation of the paddle 44p-1.

In another aspect of the embodiments described herein, a controller assembly for an overhead crane. The assembly includes a controller having a control module including a paddle configured to be rotatable to control an operation of the crane, and a lockout device mounted to the controller and including a static arm structure structured to engage the paddle to prevent rotation of the paddle. In a particular aspect, the arm structure includes an arm having a cavity extending therealong, and wherein a portion of the paddle is received in the arm cavity to provide engagement between the paddle and the arm structure. In another particular aspect, the arm structure includes a projection having a cavity extending therealong, and wherein a portion of the paddle is received in the projection cavity to provide engagement between the paddle and the arm structure.

In the above detailed description, reference is made to the accompanying figures, which form a part hereof. In the figures, similar symbols typically identify similar components, unless context dictates otherwise. The illustrative embodiments described in the detailed description, figures, and claims are not meant to be limiting.

Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

1. A lockout device for a crane remote controller, the crane remote controller having a housing including a first bearing wall, a second bearing wall extending generally perpendicularly from the first bearing wall, and a crane control module abutting the first bearing wall and the second bearing wall, the crane control module including a rotatable paddle, the lockout device comprising:
a first bearing portion structured to abut the first bearing wall;
a second bearing portion structured to abut the second bearing wall;
a base extending between the first and second bearing portions and defining a flat plane; and
an arm structure including an arm extending from the base along the flat plane and configured to engage the paddle when the first bearing portion abuts the first bearing wall and the second bearing portion abuts the second bearing wall, to prevent rotation of the paddle.

2. The lockout device of claim 1, wherein the arm includes an arm cavity extending therealong and structured to receive a portion of the paddle therein.

3. The lockout device of claim 2, wherein the arm cavity is tapered so as to narrow in a direction extending from the base toward a distal end of the arm.

4. The lockout device of claim 1, wherein the arm structure further comprises a projection extending from a free end of the arm and including a projection cavity extending therealong and intersecting the arm cavity, the arm cavity being structured to receive a portion of the paddle therein.

5. The lockout device of claim 14, wherein the projection further includes a first lock hole formed in the first projection wall and a second lock hole formed in the second projection wall opposite the first lock hole.

6. The lockout device of claim 1, wherein the second bearing portion extends substantially orthogonally with respect to the first bearing portion.

7. The lockout device of claim 1, wherein the arm has a longitudinal axis extending at 45°±a tolerance value with respect to one of the first and second bearing planes.

8. The lockout device of claim 1, further comprising a hole formed in the base.

9. A controller assembly for an overhead crane, the assembly comprising:
a controller having a control module including a paddle configured to be rotatable to control an operation of the crane; and
a lockout device mounted to the controller and including
a first bearing portion defining a first bearing plane abutting a first bearing wall of the controller;
a second bearing portion defining a second bearing plane intersecting the first bearing plane and abutting a second bearing wall of the controller;
a base extending between the first and second bearing planes and defining a flat plane; and
a static arm structure extending from the intersection along the flat plane and engaging the paddle to prevent rotation of the paddle.

10. The controller assembly of claim 9, wherein the arm structure includes an arm having a cavity extending therealong, and wherein a portion of the paddle is received in the arm cavity.

11. The controller assembly of claim 9, wherein the arm structure includes a projection having a cavity extending therealong, and wherein a portion of the paddle is received in the projection cavity.

12. The lockout device of claim 1, further comprising a surface extending parallel with the flat plane and spaced apart from the flat plane to define a floor of an arm cavity, the surface being connected to the flat plane by a first arm wall extending in a first direction from the flat plane, and a second arm wall positioned opposite the first arm wall.

13. The lockout device of claim 12, wherein the arm cavity has a closed end and an open end spaced apart from the closed end in a direction extending from the intersection toward a distal end of the arm.

14. The lockout device of claim 12, further comprising a projection including a first projection wall extending from the first arm wall, a second projection wall extending from the second arm wall opposite the first projection wall, and a floor connecting the first and second projection walls, the first and second projection walls and the floor, in combination, defining a projection cavity therebetween.

15. The lockout device of claim 1, further comprising a first flange connecting the first bearing portion with the arm along the first arm wall, and a second flange connecting the second bearing portion with the arm along the second arm wall.

16. The lockout device of claim 1, further comprising a projection including a first projection wall extending from the flat plane, a second projection wall extending from the flat plane opposite the first projection wall, and a floor connecting the first and second projection walls, the first and second projection walls and the floor, in combination, defining a projection cavity therebetween.
